(19) United States
(12) Patent Application Publication
(10) Pub. No.: US 2010/0276253 A1
(43) Pub. Date: Nov. 4, 2010

(54) Transportation of underground mined materials utilizing a magnetic levitation mass driver in a small shaft

(76) Inventor: Kevin John Ashley, Redwood City, CA (US)

Correspondence Address: Kevin J. Ashley, 2673 Carolina Ave., Redwood City, CA, 94061-3242, US

(21) Appl. No.: 12/799,179

(22) Filed: Apr. 20, 2010

Related U.S. Application Data
(60) Provisional application No. 61/214,909, filed on Apr. 30, 2009.

(51) Int. Cl. B65G 35/08; B66B 15/08; B66B 17/08; B66B 5/28; B66B 17/10

(52) U.S. Cl. 198/617; 187/249

(57) ABSTRACT

A conveyance system that utilizes an electromagnetic levitation motor acting as a mass driver to transport mined materials via a small shaft wherein multiple small skips are in transit simultaneously and which allows for return of the skips via the same route wherein the mass driver is used as a braking mechanism. The system also includes guideways to keep the skips in the correct position during transit, a safety system to prevent skips from falling back during a power failure, a system for feeding the skips to the mass driver at the lower end, and a headframe system for capturing skips at the upper end, unloading them, and feeding them back to the mass driver for the descent to the bottom.

### PRIORITY STATEMENT

This non-provisional patent application claims priority based on provisional patent application No. 61/214,909 filed on Apr. 30, 2009.

### CROSS-REFERENCE TO RELATED APPLICATIONS

Not Applicable

### STATEMENT REGARDING FEDERALLY FUNDED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Standard operation of underground mines often includes vertical, or near-vertical, transport of mined materials using elevator technology whose key components are a shaft with guideways, a bucket or skip to contain the transported material, a fiber or wire rope to suspend the skip, and a hoisting mechanism to draw the skip to the top of the shaft. The capacity of such a configuration is set by the size of the skip, the speed of hoisting, and the power of the hoist; but in all cases only one skip can be used per guideway at any one time.

During the latter half of the twentieth century, advances in electromagnets and associated control systems allowed for the development of magnetic levitation transportation devices and mass drivers, utilizing linear induction motors (LIMs) or linear synchronous motors (LSMs) for propelling loads horizontally and vertically. In particular see U.S. Pat. No. 7,448,327 and materials referenced therein.

Application of electromagnetic drive systems to vertical transport of mine material has been previously evaluated; however only with the goal of increasing the efficient depth of operation of existing rope hoist systems utilizing large skips. See U.S. Pat. No. 6,513,627.

Such a system can increase the efficiency of existing systems, but still limits each guideway to only one skip. In the case of a mass driver that relies on levitation and propulsion supplied solely by the electromagnets, the need for a rope or cable can be completely eliminated allowing multiple skips to use a single guideway simultaneously. As such, a similar capacity to a rope hoisting system using one large skip can be attained using a smaller diameter shaft with multiple smaller skips.

### BRIEF SUMMARY OF THE INVENTION

The object of the invention is to allow vertical, or near vertical, transport of mined materials through small openings, possibly drilled, that can be less expensively excavated than shafts often used with rope hoisting systems. Into such smaller openings will be installed a magnetic levitation motor system, along one or two sides, with guideways. Skips made of appropriate materials, will contain a fraction of the load carried by the larger rope hoist skip systems, however since multiple skips will be able to transit the magnetic drive system simultaneously, the capacity of the system can be equal to or greater than a rope hoist skip system operating in a larger diameter shaft.

Control systems integral to the magnetic levitation drive system will ensure appropriate spacing between skips. Negative air pressure will be maintained at the top of the shaft to facilitate passage of the skips and remove heated air from the drive system. The skips will be aerodynamically shaped to facilitate passage up the shaft. At the upper end of the shaft, the skips will enter a purpose built headframe that will convey them to a dumping location where they will be automatically opened and their contents allowed to fall into a bin or other conveyance. The skips, appropriately closed, will then proceed back to the shaft and down to the lower end. The speed of this descent will be regulated by the electrical retardation of the magnetic levitation system. As possible, the energy generated during the fall of the skips will be captured and used in subsequent lifting. Incorporated within the guideway system will be a series of stops held in place electromagnetically. In case of a power failure, these stops will lean toward the center of the shaft to facilitate the slowing and catch any skips that are in mid-transit. This will allow transport to continue in the appropriate direction once power has been restored.

The guideways will be made of ferrous or non-ferrous materials as necessary and the skips will be made of appropriate materials with magnetic components, if necessary, to increase the efficiency of the drive system. Wheels, either on the skips or on the guideway, will facilitate transport and keep appropriate clearances within the drive system.

### BRIEF DESCRIPTION OF THE SEVERAL VIEWS OF THE DRAWING

FIG. 1 is a conceptual drawing of the upper and lower portions of the shaft with skips in transit.

FIG. 2 is a detail of a portion of the shaft where a skip is in transit.

### DETAILED DESCRIPTION OF THE INVENTION

Implementation of mined material vertical, or near vertical, transport will include excavation of a shaft 1, insertion or construction of guideways 10 and magnetic levitation motors(s) 11, construction of headframe apparatus 2 for receiving, dumping and reinserting the skips, construction of a bin 3 to receive the transported material, skip handling equipment at the lower end of the shaft 4, and control systems 5 for ensuring appropriate spacing and motivation/retardation of multiple skips 6 in transit. The following describes one configuration to explain the workings of the system and addresses those items that are unique to the invention. Additional configurations that would conform to optimization of specific applications are also applicable.

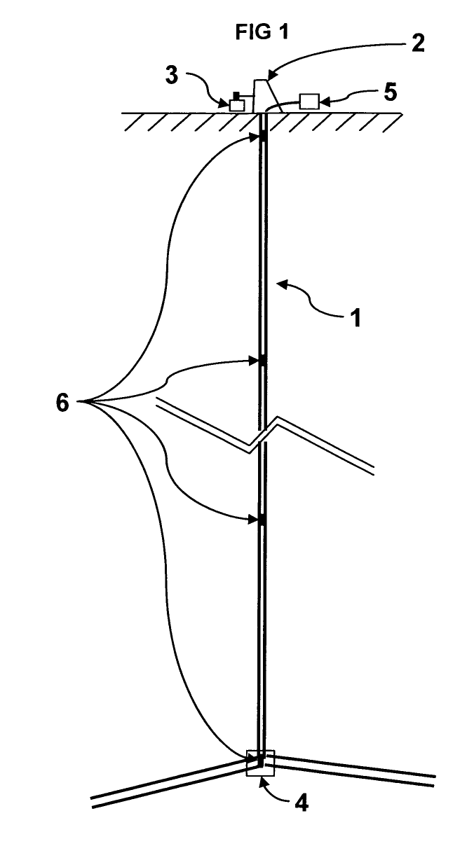

In FIG. 1, a shaft 1 less than 1.5 meters diameter is shown of a depth of hundred of meters. Such a shaft could be drilled or back-reamed. At the lower end, skips 6 of about two thirds the diameter of the shaft square and two to three times as long (plus aerodynamic ends) will be loaded with a few tonnes of rock each for transport to the surface. Skips will travel in groups up the shaft and down the shaft together at a speed similar to a high speed elevator in an office building. Considering delays due to dumping at the surface, this would result in an adequate hoisting capacity for a reasonable size mine. TABLE 1 shows an example of the dimensions, progression, and capacity that could be attained for a particular configuration.

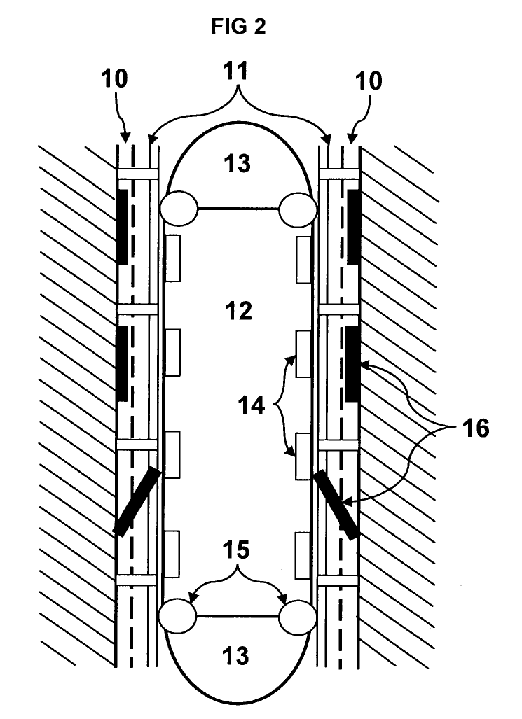

FIG. 2 shows the details of a skip in transit within a section of the shaft. This includes electromagnetic levitation motors 10 on each side of the shaft which are protected from the skip by the guideways 11. The guideways 11 also serve to maintain appropriate spacing between the electromagnetic levitation motors and the skips for motive purposes. The skip 12 is shown with a length to width ratio of 3:1, not including the aerodynamic end caps 13. Permanent magnets 14 are shown inside the skip to improve motive forces and wheels 15 are shown at each end of the skip where they contact with the guideway. Safety arms 16 are shown in both the extended and retracted positions. Should power be lost, these arms would extend in order to catch skips before they fall more than a short distance.

TABLE 1
Prototypical Dimensions and Operation of Installation

| For the following assumptions: | |
|---|---|
| Ore Density = 2.0 t/m3 | |
| Skip Material Density = 8.0 t/m3 | |
| Skip Material Thickness = 0.01 m | |
| Skip Speed = 30 m/s | |
| Hoisting Distance = 690 m | |
| Dumping Time = 30 seconds | |
| The system dimensions and capacities would be: | |
| Skip Capacity = 2.0 t | |
| Skip Weight = 2.5 t | |
| Shaft Diameter = 1.0 m | |
| Skip Width = 0.7 m | |
| Skip Length = 2.1 m | |
| Skips operating in groups of 6 (12 t total) as follows: | |
| Time | Event |
| 0 sec | 1^{st} Skip leaves Bottom of Shaft |
| 5 sec | 2^{nd} Skip leaves Bottom of Shaft |
| 10 sec | 3^{rd} Skip leaves Bottom of Shaft |
| 15 sec | 4^{th} Skip leaves Bottom of Shaft |
| 20 sec | 5^{th} Skip leaves Bottom of Shaft |
| 23 sec | 1^{st} Skip reaches top of Shaft |
| 25 sec | 6^{th} Skip leaves Bottom of Shaft |
| 28 sec | 2^{nd} Skip reaches top of Shaft |
| 33 sec | 3^{rd} Skip reaches top of Shaft |
| 38 sec | 4^{th} Skip reaches top of Shaft |
| 43 sec | 5^{th} Skip reaches top of Shaft |
| 48 sec | 6^{th} Skip reaches top of Shaft |
| 53 sec | 1^{st} Skip leaves top of Shaft (after 30 sec dumping) |
| 58 sec | 2^{nd} Skip leaves Top of Shaft |
| 63 sec | 3^{rd} Skip leaves Top of Shaft |
| 68 sec | 4^{th} Skip leaves Top of Shaft |
| 73 sec | 5^{th} Skip leaves Top of Shaft |
| 76 sec | 1^{st} Skip reaches Bottom of Shaft |
| 78 sec | 6^{th} Skip leaves Top of Shaft |
| 81 sec | 2^{nd} Skip reaches Bottom of Shaft |
| 86 sec | 3^{rd} Skip reaches Bottom of Shaft |
| 91 sec | 4^{th} Skip reaches Bottom of Shaft |
| 96 sec | 5^{th} Skip reaches Bottom of Shaft |
| 101 sec | 6^{th} Skip reaches Bottom of Shaft |
| 111 sec | 1^{st} Skip of next group leaves Bottom of Shaft |

Shaft Hoisting Rate = 389 t/h (12 tonnes every 111 seconds)

What is claimed as invention is:

1. A method of transportation of mined materials utilizing the following components:
a) An appropriately sized small diameter shaft installed by drilling or back-reaming,
b) Electromagnetic levitation motors installed on opposite sides of the shaft with appropriate control system to maintain separation between skips in transit,
c) Guideways installed within the shaft to direct skips and to keep them at appropriate distance from the motor(s),
d) Appropriately sized small capacity skips made of materials that work with the electromagnetic levitation motor(s) and have wheels along the sides to make contact with the guideway(s),
e) A safety system of electromagnetically constrained stops for slowing and/or supporting skips in case of power failure,
f) A sequence of multiple skip transit that allows hoisting utilizing a single shaft for both up and down.

2. The method claimed in 1, wherein the shaft is excavated by other means than drilling or back-reaming.

3. The method claimed in 1, wherein separate shafts are used for transit up and down.

4. The method claimed in 1, wherein personnel or materials other than mined materials are transported.

5. The method claimed in 1, wherein only one electromagnetic levitation motor is utilized.

6. The method claimed in 1, wherein more than two levels (Bottom and Top) are accessed or to which material is delivered.

7. The method claimed in 1, wherein the electromagnetic levitation motor system is lowered into the shaft as an integrated unit, as a whole or in components.

8. The method claimed in 1, wherein the electromagnetic levitation motor system and/or guideways may be removed and re-installed in an alternate shaft.

9. The method claimed in 1, wherein a mechanical safety system is utilized.

10. The method claimed in 1, wherein no safety system that uses direct physical contact for slowing and/or supporting the skips is used.

11. The method claimed in 1, wherein the guideways are installed on the same side(s) of the shaft as the electromagnetic levitation motor(s).

12. The method claimed in 1, wherein the guideways are installed on the side(s) of the shaft perpendicular to the side where the electromagnetic levitation motor(s) are installed.

13. The method claimed in 1, wherein the wheels are installed on the guideway instead of the skips,

14. The method claimed in 1, wherein no wheels are used and proper clearances are maintained utilizing the electromagnetic levitation system,

15. The method claimed in 1, wherein the safety system is installed on the same side(s) of the shaft as the electromagnetic levitation motor(s).

16. The Method claimed in 1, wherein the safety system is installed on the side(s) of the shaft perpendicular to the side where the electromagnetic levitation motor(s) are installed.

17. The Method claimed in 1, wherein adequate capacitance or battery storage is provided to capture the energy generated by falling skips.

18. The Method claimed in 1, wherein permanent magnets are not included as part of the skips.

19. The Method claimed in 1, wherein the shaft is not vertical.
